(19) United States
(12) Patent Application Publication
(10) Pub. No.: US 2023/0222704 A1
(43) Pub. Date: Jul. 13, 2023

(54) SYSTEMS AND METHODS FOR VISUALIZING NATURAL SPACES USING METAVERSE TECHNOLOGIES

(71) Applicant: General Reality Systems, LLC, Austin, TX (US)

(72) Inventors: Luiz von Paumgartten, Austin, TX (US); David von Paumgartten, Buda, TX (US); James von Paumgartten, Austin, TX (US)

(73) Assignee: General Reality Systems, LLC, Austin, TX (US)

(21) Appl. No.: 18/092,317

(22) Filed: Jan. 1, 2023

Related U.S. Application Data
(60) Provisional application No. 63/297,875, filed on Jan. 10, 2022.

(51) Int. Cl. G06T 11/00; G06N 3/006; G06T 7/246; G06F 3/01; G06T 13/40; G06T 3/40

(52) U.S. Cl. CPC G06T 11/00; G06N 3/006; G06T 7/246; G06F 3/012; G06T 13/40; G06F 3/017; G06T 3/40; G06T 2207/30201; G06T 2210/62

(57) ABSTRACT

Systems and methods for visualizing Natural Spaces using metaverse technologies are described. In some embodiments, a system may include a processor and a memory coupled to the processor, the memory having program instructions stored thereon that, upon execution, cause the system to: render or project a first graphical feature on a display, and at least one of: (a) replace a portion of the first graphical feature with a second graphical feature, or (b) overlay the second graphical feature upon the portion of the first graphical feature, to indicate a distinction between a user's visual perception of an environment and the environment.

### CROSS-REFERENCE TO RELATED APPLICATIONS

This application claims the benefit of U.S. Provisional Patent Application No. 63/297,875, filed on Jan. 10, 2022, the disclosure of which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field

The present disclosure relates generally to computer systems, and, more particularly, to systems and methods for visualizing Natural Spaces using Metaverse technologies.

### Background

A “Metaverse” is a computer-generated world where users can experience one or more aspects of their lives virtually. Early adopters of Metaverse technologies (e.g., Virtual Reality, Augmented Reality, Mixed Reality, etc.) work, play, learn, and maintain social connections in one or more such worlds, with varying degrees of immersion. In a not-too-distant future, human beings are expected to spend a significant portion of their waking hours in some type of Metaverse.

### BRIEF SUMMARY

Embodiments of systems and methods for visualizing Natural Spaces using Metaverse technologies are described.

In an illustrative, non-limiting embodiment, a system may include a processor and a memory coupled to the processor, the memory including program instructions stored thereon that, upon execution, cause the system to: render or project a first graphical feature on a display; and at least one of: (a) replace a portion of the first graphical feature with a second graphical feature, or (b) overlay the second graphical feature upon the portion of the first graphical feature, to indicate a distinction between a user's visual perception of an environment and the environment.

The first and second graphical features may include at least one of: a color, a hue, a filter, an effect, a texture, or an image.

The user's visual perception of the environment may be produced within a first Natural Space, and the environment may be part of a second Natural Space.

The program instruction, upon execution by the processor, may cause the system to maintain the second graphical feature at a same relative location in a Field-of-View (FOV) of a user as the user moves.

At least one of the first or second graphical features may be translucent.

The program instructions, upon execution by the processor, may cause the system to, at least one of: (i) replace a portion of the first graphical feature with a third graphical feature, (ii) replace a portion of the second graphical feature with the third graphical feature, (iii) overlay the third graphical feature along at least a portion of a perimeter of the first graphical feature, or (iv) overlay the third graphical feature along at least a portion of a perimeter of the second graphical feature.

The distinction between the user's visual perception of the environment and the environment may be indicated in response to at least one of: (i) a gesture including an unwrap, unveil, slide, swipe, lift, unzip, wave, etc. (ii) a command including a keypress, a mouse click, a button push, an audio command, a typed command, a programmed command, etc. or (iii) an event including an object detection, a game event, an application event, etc.

The program instructions, upon execution by the processor, may cause the system to increase a size of the second graphical feature in response to an increase in a range, magnitude, or speed of the gesture.

The program instructions, upon execution by the processor, may cause the system to reduce a size of the second graphical feature in response to a decrease in a range, magnitude, or speed of the gesture.

The program instructions, upon execution by the processor, may cause the system to, in response to another gesture, command, or event: (i) remove the second graphical feature, or (ii) replace the second graphical feature with the first graphical feature.

For example, the other gesture may be opposite to the gesture.

The program instructions, upon execution by the processor, may cause the system to, in response to a person being visible to a user through the second graphical feature, render or project a third graphical feature upon a portion of the display corresponding to the person's head.

The third graphical feature may include a translucent shape having a closed end covering a bottom portion of the person's head, and an open end above the person's head.

The program instructions, upon execution by the processor, may cause the system to, in response to at least a portion of the person's head not being visible to the user through the second graphical feature, omit, reduce, or remove at least a portion of the third graphical feature.

The program instructions, upon execution by the processor, may cause the system to animate the third graphical feature.

The program instructions, upon execution by the processor, may cause the system to track at least one of: the person, or the person's head; and modify a position of the third graphical feature to follow at least one of: the person, or the person's head.

The program instructions, upon execution by the processor, may cause the system to, at least one of: (i) replace a portion of the third graphical feature with a fourth graphical feature, or (ii) overlay the fourth graphical feature upon a portion of the third graphical feature.

The program instructions, upon execution by the processor, may cause the system to, in response to a determination that the fourth graphical feature is visible to the user through the second graphical feature, trigger a command, action, or interaction between the user and the person.

In another illustrative, non-limiting embodiment, a memory device may have program instructions stored thereon that, upon execution by a processor, cause a MAD to: detect a gesture, command, or event; and, in response to the detection, overlay a graphical feature upon a user's view of an environment to indicate a boundary between two or more Natural Spaces.

In yet another illustrative, non-limiting embodiment, a method may include operating a MAD and visually identifying a first Natural Space as distinct from a second Natural Space as a result of the operation.

### DESCRIPTION OF THE DRAWINGS

The present invention(s) are illustrated by way of example and are not limited by the accompanying figures. Elements in the figures are illustrated for simplicity and clarity, and have not necessarily been drawn to scale.

FIG. 1 illustrates an example of a Metaverse Access Device (MAD), according to some embodiments.

FIG. 2 illustrates an example of a compute unit, according to some embodiments.

FIG. 3 illustrates an example of a system for visualizing Natural Spaces, according to some embodiments.

FIG. 4 illustrates an example of a method for visualizing Natural Spaces, according to some embodiments.

FIGS. 5A-E illustrate examples of Augmented Reality (AR) or Mixed Reality (MR) views provided to a user of a MAD device, according to some embodiments.

FIG. 6 illustrates an example of an AR/MR view, as seen by the user of a MAD device, of another person operating another MAD device, according to some embodiments.

### DETAILED DESCRIPTION

The invention(s) described herein relate to systems and methods for visualizing Natural Spaces using Metaverse technologies. Prior to embarking on such a peculiar voyage, it may be advisable to make certain preparations. Accordingly, we shall begin the description of our invention(s) with a succinct treatment of selected concepts believed to be necessary for an appreciation of Natural Reality.

### Glossary of Terms

“Natural Reality”—the state of things as they are—presents itself through the concurrent operation of a plurality of Natural Spaces.

The term “Natural Space” refers to an environment containing real entities that interact with one another following the enforcement of one or more Rule(s) of Causation applicable thereto.

A “real entity” or “entity” is a thing (and/or aspect(s)/feature(s) thereof) that exists and is subject to observation.

A “Rule of Causation” (Ψ) is a rule that, upon enforcement, turns a cause (c) into an effect (e), thereby enabling interactions among entities. Each Natural Space enforces its own set of Rule(s) of Causation.

The term “cause” (c) relates to an event that produces an outcome or result under the enforcement of a Rule of Causation.

The term “effect” (e) refers to an outcome or result of a cause, as produced by the enforcement of a Rule of Causation.

An “interaction” is an event where two or more entities affect one another under application of one or more Rule(s) of Causation.

“Change” (δ) refers to an act or instance of making or becoming different.

“Decay” (λ) refers to a state or process of impermanence whereby entities become non-observable.

### Principles of Natural Reality

In a Natural Space, entities interact.

Interactions produce, in each participating entity, change (δ) and decay (λ).

Consequently, the Principle of General Selection applies: if a changed entity combats decay more effectively than other entities, by virtue of prevailing over the other entities, the changed entity may be deemed to have been selected.

In interactions, enforcement of Ψ turns c into e, such that:

Ψ: c→e, where e=δ+λ.

For each interaction: if δnegates λ (180°), e is deemed constructive; if δ affirms λ (0°), e is deemed destructive; and if δdoes not affect λ (90°), e is deemed neutral.

An entity's immunity to the application of Ψ is referred to as its “Causation Impedance” (Z) with respect to Ψ, or Z_{Ψ}.

With respect to an entity having Z_{Ψ}, the result of an interaction governed by Ψ is given by:

c∝Z_{Ψ}x e.

Hence, for a given c, an entity having a larger Z_{Ψ} is less susceptible toΨ, and therefore subject to a smaller e. Conversely, for the same c, an entity having a smaller Z_{Ψ} is more susceptible to Ψ, and therefore subject to a larger e.

“Causation Incoherence” (Δ) is produced when δ increases an entity's Z_{Ψ}, thus allowing that entity to escape the application of Ψ.

Once General Selection produces an accumulation of Δ, resulting entities emerge from an underlying Natural Space and interact with like entities, at least in part, governed by different Rule(s) of Causation, thus forming an overlying Natural Space.

To illustrate the operation of Natural Reality, consider a first Natural Space (n−1) (a “blue space”) where entities of a first type (“blue entities”) having Zₙ₋₁ interact with each other governed by Ψₙ₋₁.

Through application of General Selection, accumulation of Δ among blue entities yields entities of a second type (“green entities”) having Zn.

Green entities interact with each other governed by Ψₙ, thus forming a second Natural Space (n) (a “green space”) overlying the blue space.

In the green space, green entities continue to undergo General Selection. As a result, accumulation of Δ among green entities yields entities of yet another, third type (“red entities”) having Zₙ₊₁.

Red entities interact with each other governed by Ψₙ₊₁, thus forming a third Natural Space (n+1) (a “red space”) overlying the green space, and so on.

A Natural Space persists so long as: (1) δ successfully combats λ, both in that Natural Space and in its underlying Natural Space(s), and (2) across Natural Spaces, Δ remains sufficiently harmonized.

For ease of understanding, one may discretize a Natural Space by modeling it to include entities of a same (or similar) type, and to exclude any entity of any other type.

For example, an observer may adopt a perspective where the Universe constitutes a first Natural Space of entities recognized as having a physical character (a “blue space”). Another, second Natural Space, is the biological world, made of entities defined as living or organic (a “green space”). Yet another, third Natural Space, is an individual mind, where abstract entities of perception and/or interpretation are handled (a “red space”).

In the biological world, General Selection is referred to as “Natural Selection.” Within an individual mind, the same General Selection mechanism produces “learning.”

In light of the foregoing, the inventors hereof have recognized that human beings are not natively well-equipped to make distinctions between Natural Spaces, nor the different types of entities found therein.

For instance, when a person sees an object, they are likely to treat: (1) the actual object, a physical entity that exists in the Universe (a first Natural Space), and (2) their visual perception of the object, an abstraction produced by their individual mind (a second Natural Space), as if the two entities were the same thing.

A person's inability to distinguish their individual, inner world from the shared, outer world, may be referred to as a “Blindfold.” Moreover, a person's lack of awareness of their own Blindfold is believed to give rise to various human condition issues, ranging from chronic loneliness to mental and behavioral disorders.

The inventors hereof expect the widespread dissemination of Metaverses to tighten the human Blindfold by distancing its users from Natural Reality even more.

To address these, and other concerns, systems and methods described herein enable the visualization of Natural Spaces. In various embodiments, these systems and methods may employ the same Metaverse technologies prone to aggravate the human condition, to instead ameliorate it.

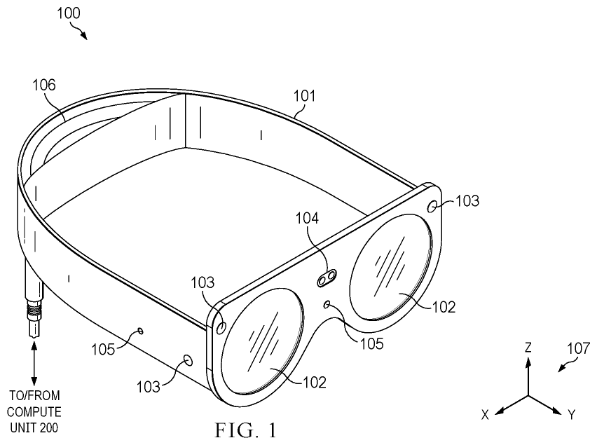

FIG. 1 illustrates an example of Metaverse Access Device (MAD) 100. This implementation of MAD 100 may be referred to as: glasses, goggles, headset, Head-Mounted Device (HMD), Head-Mounted Display (also “HMD”), or the like.

As shown., frame 101 may be worn around a user's head, with display(s) 102 positioned before user's eye(s) 313. In other implementations, however, MAD 100 may assume other form factors (e.g., tablet, smartphone, etc.) such that display(s) 102 may be positioned before the user's eyes when MAD 100 is held up to the user's face. To account for both scenarios, the terms “user” and “wearer” may be used interchangeably herein.

Generally, MAD 100 may be configured to provide its user with a direct or see-through, natural view of the entities that surround them, and to augment that view with one or more graphical features or “overlays.” Each different overlay may represent a distinct Natural Space made observable to the user. In operation, MAD 100 may add or remove overlay(s) to portion(s) of the user's natural view of their environment to visually represent, via display(s) 102, the presence or absence of a Natural Space in that environment.

Examples of Natural Spaces made visible through MAD 100 include, but are not limited to: (1) the Universe at large (shared space 301), (2) the user's individual mind, and/or (3) the individual minds of other persons or biological entities.

Additionally, or alternatively, the user's view may be a digital reproduction (captured by camera(s) 103) of their natural view, in which case overlay(s) representing different Natural Space(s) may be rendered upon the digitally reproduced view.

As depicted in FIG. 1, one or more outward facing camera(s) 103 may be coupled to frame 101 of MAD 100 in position(s) configured to capture digital images of the environment surrounding the user. For example, relative to X-Y-Z coordinate system 107, two cameras may be directed forward (+Y), one camera may be directed to the left (−X), and another camera may be directed to the right (+X).

Depth sensor(s) 104 coupled to frame 101 may include, for example: a time-of-flight depth sensor, an infrared sensor, or the like. In some cases, depth sensor(s) 104 may be used to survey a depth shared space 301 by storing a distance value (Z) for each pixel (X, Y) of an image captured by camera(s) 103.

Microphone(s) 105 and other sensors (not shown. but disposed in rear portion 106 of MAD 100) may include, but are not limited to: accelerometer(s), gyroscope(s), rotation sensor(s), IR sensor(s), proximity sensor(s), photosensor(s), magnetometer(s), ultrasonic sensor(s), audio loudspeaker(s), brain scanner(s), Simultaneous Localization and Mapping (SLAM) sensor(s), Inertial Measurement Unit (IMU) sensor(s), etc.

Camera(s) 103 may capture images of the environment around MAD 100 (shared space 301), which may be used to produce images on display(s) 102 and to ascertain movement of MAD 100.

Moreover, an accelerometer may detect the direction of Earth's gravitational force, which may also be used to determine the orientation of MAD 100.

In various implementations, a combination of camera(s) 103 images, depth sensor(s) 104 data, and head pose operations that employ SLAM and/or IMU outputs may be collectively used to establish the locations of surfaces, landmarks, objects, and other entities in shared space 301 relative to MAD 100, such that the movement of MAD 100 may be calculated with respect to a map of shared space 301.

Display(s) 102 may include one or more transparent display(s), such as a transparent Organic Light Emitting Diode (OLED) film or glass.

In operation, MAD 100 may dynamically superimpose or overlay 2D or 3D computer-generated graphical features over physical objects, surfaces, and entities, at least in part, by rendering those graphical features on display(s) 102 and/or projecting light toward user's eye(s) 313 via display(s) 102.

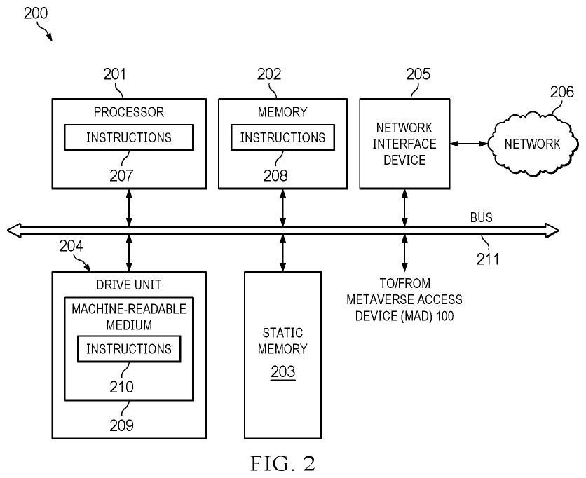

In various embodiments, the processing of signals collected by camera(s) 103, depth sensor(s) 104, microphone(s) 105, and other sensors coupled to MAD 100, as well as the processing of images rendered or by display(s) 102 or projected thereon, may be performed, at least in part, by compute unit 200 of FIG. 2.

FIG. 2 illustrates an example of compute unit 200 configured to enable the visualization of Natural Spaces. In some cases, one or more components of compute unit 200 may be coupled to MAD 100 over a wired or wireless connection. Additionally, or alternatively, one or more components of compute unit 200 may be near or remotely located with respect to MAD 100. Additionally, or alternatively, one or more components of compute unit 200 may be included and/or integrated into MAD 100.

One or more sets of program instructions may, upon execution, cause compute unit 200 to perform the various operations described below. In some embodiments, compute unit 200 may be connected (e.g., networked) to other computers. In that regard, compute unit 200 may include any collection of computers that individually or jointly execute a set (or multiple sets) of instructions.

As shown, compute unit 200 includes processor 201 (e.g., a Central Processing Unit or “CPU,” a Graphics Processing Unit or “GPU,” etc.), main memory 202 (e.g., Read Only Memory or “ROM,” flash memory, Dynamic Random Access Memory or “DRAM” such as Synchronous DRAM or “SDRAM,” etc.), and static memory 203 (e.g., flash memory, Static Random Access Memory or “SRAM,” etc.), which may communicate with each other via bus 211.

Compute unit 200 may also include drive unit 204 (e.g., a Hard Disk Drive or “HDD”) and Network Interface Device 205 (e.g., “NIC,” modem, etc.). Disk drive unit 204 includes machine-readable medium 209 on which one or more sets of program instructions 210 embodying any of the methods or operations described herein may be stored. Program instructions may also reside, completely or at least partially, within machine-readable media of main memory 202 (e.g., as instructions 208) and/or within processor 201 (e.g., as instructions 207 during execution).

In some cases, program instructions 207, 208, and/or 210 (as well as data associated therewith) may be stored in a centralized database, two or more distributed databases, or remote servers. To that end, program instructions 207, 208, and/or 210, associated data, commands, and/or messages may be transmitted and received over network 206 (e.g., the Internet) via NIC 205.

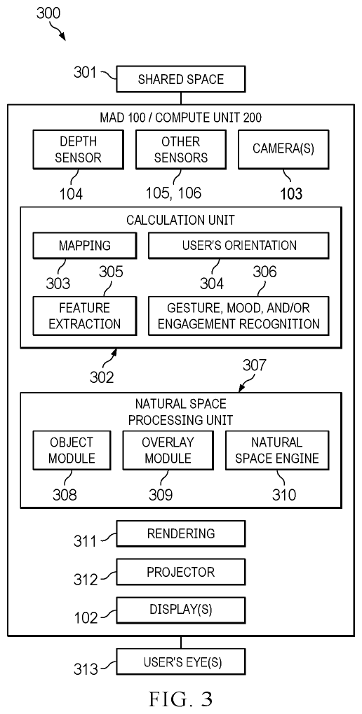

FIG. 3 illustrates an example of system 300 for enabling the visualization of Natural Spaces. In some embodiments, components of system 300 may be instantiated in response to the execution of program instructions 207, 208, and/or 210 by compute unit 200 in cooperation with MAD 100.

Particularly, system 300 may allow user's eye(s) 313 to capture light in a manner that enables the user's mind to produce its own visual perception of shared space 301, the physical environment surrounding them (where the user's body exists). Such view may include the user's direct or see-through, natural view of shared space 301, and/or it may include a digital reproduction thereof.

The user's view of shared space 301 may be augmented with graphical features or overlays produced by calculation unit 302 and Natural Space processing unit 307. Graphical features may be projected by projector 312 on display(s) 102, or otherwise rendered by display(s) 102. Each graphical feature may indicate, to the user, the presence of a corresponding Natural Space and/or boundaries therebetween.

For example, system 300 may provide user's eye(s) 313 with Augmented Reality (AR) views, Mixed Reality (MR) views, or the like. The AR/MR views may include overlays produced by calculation unit 302 using data received from camera(s) 103, depth sensor(s) 104, and/or other sensor(s), as handled by Natural Space processing unit 307.

Each overlay produced by system 300 may be static or moving (animated), 2-dimensional (2D) or 3-dimentional (3D), opaque or translucent (with selectable degrees of translucency).

Projector 312 may be configured to convert data generated by rendering engine 311 into light and to deliver that light to display(s) 102. Light produced by projector 312 may travel from display(s) 102 towards user's eye(s) 313.

In some implementations, to provide the user with a 3D experience, each of their eyes may be presented with a different image, effect, texture, and/or overlay. Moreover, render images, effects, textures, and/or overlays at proper depths, at some distance behind display(s) 102, projector 312 may be configured emit light rays with configurable angles of divergence.

Calculation unit 302 may include: mapping module 303, user's orientation module 304, feature extraction module 305, and gesture, mood, and/or engagement recognition module 306.

Mapping module 303 may be configured to receive input(s) from MAD 100 to determine the locations of surfaces, objects, and entities in shared space 301.

User's orientation module 304 may be configured to determine the user's orientation and/or head pose (e.g., using an IMU) relative to objects identified by feature extraction module 305 in shared space 301.

Feature extraction module 305 may be configured to identify, in one or more images of shared space 301 captured by camera(s) 103, elements such as: objects, surfaces, shapes, landmarks, biological entities (e.g., human beings), body parts (e.g., head, face, eyes, ears, mouth, arm, hand, fingers, fingertips, etc.), etc.

Examples of feature extraction techniques and algorithms usable by module 305 to identify these elements may include, but are not limited to: edge detection, corner detection, blob detection, ridge detection, scale-invariant feature transforms, thresholding, template matching, Hough transforms, etc.

Gesture, mood, and/or engagement recognition module 306 may employ any gesture recognition technique, algorithm, or model suitable to identity, in one or more images captured by camera(s) 103, one or more hand/finger gestures performed by the user of MAD 100 and/or by other entities in shared space 301.

In some cases, a virtual skeleton may be fit to at least one body part (e.g., a human arm, hand, finger(s), fingertip(s), etc.) and a designation may be assigned to each joint/segment. Each joint/segment may be associated with parameters specifying its position, angle of rotation, a form or shape of an associated body part (e.g., hand open, hand closed, etc.), and so on.

By analyzing positional change in various skeletal joints and/or segments, gesture, mood, and/or engagement recognition module 306 may identify movements that indicate predetermined gestures, actions, behaviors by the user of MAD 100 and/or of other entities in shared space 301 (e.g., person 501A).

In various implementations, gesture, mood, and/or engagement recognition module 306 may be further configured to receive, in addition to one or more images captured by camera(s) 103, audio and/or other biometric data such as: heart rate, blood pressure, oxygenation level, pupil size, gaze direction, etc., and to use that information to identify a command, mood, and/or level of engagement of the user of MAD 100 and/or other entities in shared space 301 (e.g., person 501A).

Examples of detectable moods include, but are not limited to: anxious, calm, cheerful, depressed, eerie, festive, foreboding, frightened, frustrated, hopeless, humorous, idyllic, joyful, light-hearted, lonely, melancholic, ominous, optimistic, panicked, peaceful, pensive, pessimistic, reflective, restless, romantic, sad, sentimental, stressed, tense, uneasy, etc.

Additionally, or alternatively, engagement levels may be measured on a scale from least to most engaged with another person (e.g., person 501A), other entities in shared space 301, augmented content, etc.

Still referring to system 300, Natural Space processing unit 307 may include: object module 308, overlay module 309, and Natural Space engine 310.

Object module 308 may be configured to identify and track the position of surfaces, shapes, objects, entities (e.g., biological entities), and the body parts of biological entities present in the Field-of-View (FOV) of the user, for example, within a predetermined distance from the user, using data obtained from feature extraction module 305 and/or mapping module 303.

Overlay module 309 may be configured to produce one or more augmenting graphical features including, but not limited to: images, effects, textures, or overlays. Each graphical feature may include a selected: color, filter, shape, degree of translucency, and/or animation (e.g., undulatory movements or vibration effects corresponding to different moods, etc.).

Natural Space engine 310 may be configured to receive outputs from object module 308 and overlay module 309, and to place one or more graphical features at appropriate pixel locations of display(s) 102 that correspond to Natural Spaces or boundaries therebetween, to make them visually observable to a user by system 300.

Natural Space engine 310 may also be configured to move graphical features to different pixel locations of display(s) 102, as the user's body moves and/or head pose changes (e.g., as identified and tracked by user's orientation module 304); and/or as corresponding objects, entities, of portions thereof in shared space 301 move or change positions (e.g., as identified and tracked by object module 308).

Rendering engine 311 may be configured to receive the output of Natural Space engine 310 and to produce AR/MR views for rendering or projection (e.g., by projector 312) on display(s) 102.

In some implementations, to execute one or more of various recognition (e.g., audio commands, etc.), identification, mapping, tracking, mapping, localization, feature extraction, filtering, and/or rendering operations, one or more components of system 300 may be configured to execute respective Artificial Intelligence (AI) or Machine Learning (ML) model(s).

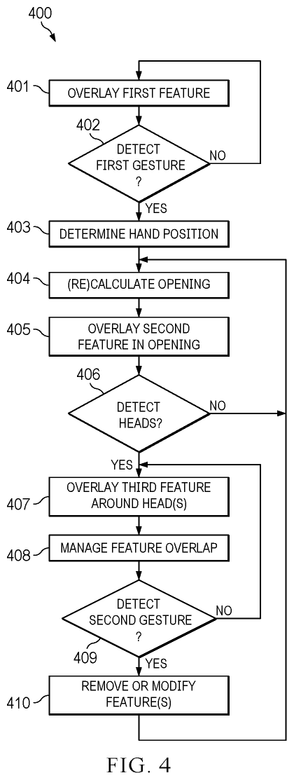

FIG. 4 illustrates an example of method 400 for enabling the visualization of

Natural Spaces. In some embodiments, method 400 may be performed, at least in part, by system 300 instantiated by MAD 100 and/or compute unit 200.

At 401, method 400 may render or project a first graphical feature (e.g., a shape, color, texture, filter, effect, translucency, etc.) upon display(s) 102 such that, to the user of MAD 100, the first graphical feature appears overlaid upon shared space 301.

The first graphical feature may modify one or more visual features of shared space 301 otherwise directly visible to the user (e.g., by adding a predominant color, tone, or hue thereto). As such, the first graphical feature may indicate, to the user, that their natural visual perception of shared space 301 is produced within a first Natural Space (which constitutes their individual mind).

In some cases, the first graphical feature may include a red hue overlaid upon all surfaces, objects, and entities present in the user's FOV to represent a so-called “red space.”

At 402, method 400 may detect a first gesture (e.g., unwrapping, unveiling, slicing, swiping, lifting, unzipping, or waving gesture), command (e.g., a keypress, mouse click, button push, audio command, typed command, programmed command), or event (e.g., object detection, game trigger, application state or event, etc.).

At 403, method 400 may determine the position of the user's arm(s), hand(s), and/or finger(s), and it may use a corresponding pixel position on display(s) 102 to determine where to introduce a first opening or gap in the first graphical feature.

Particularly, at 403, method 400 may determine the position of the user's arm(s), hand(s), and/or finger(s) to: (i) render the first opening at an initial location of display(s) 102 corresponding to the location where the gesture is being performed, (ii) maintain the first opening at a same relative location in user's FOV, and/or (iii) maintain a size of the first opening proportional or commensurate with a range, magnitude, and/or speed of the user's gesture.

At 404, method 400 may calculate, recalculate, and/or update the position and size of the first opening. For example, method 400 may increase the size of the first opening in response to an increase in the range, magnitude, and/or speed of the gesture. Conversely, method 400 may reduce the size of the first opening in response to a decrease in the range, magnitude, and/or speed of the gesture.

Still at 404, method 400 may adjust the position and/or size of the first opening in response to a change in the wearer's head pose, gaze direction, or body movement (e.g., walking, turning, etc.).

At 405, method 400 may render or project a second graphical feature 509 (e.g., a different shape, color, texture, filter, effect translucency, etc.) on a portion of display(s) 102, such that the second graphical feature represents the first opening in the first graphical feature.

In some cases, method 400 may replace a portion of the first graphical feature with the second graphical feature. In other cases, method 400 may overlay the second graphical feature upon the portion of the first graphical feature.

The second graphical feature may indicate the presence of a second Natural Space (i.e., shared space 301) that exists independently of the user's visual perception of it. Accordingly, the first and/or second graphical features may indicate, to the user, a distinction and/or a boundary between the user's visual perception of an environment (e.g., overlaid with the first graphical feature) and the environment itself (e.g., overlaid with the second graphical feature).

The second graphical feature may include a second filter that modifies visual features of portion(s) of shared space 301 otherwise directly visible to the user, through the first opening, to indicate the presence of a second Natural Space.

In some cases, the second graphical feature may include a blue hue overlaid upon all surfaces, objects, and entities present in first opening to represent a so-called “blue space.”

At 406, method 400 may determine whether system 300 detects one or more heads (e.g., other person's heads) in the user's FOV. Additionally, or alternatively, one or more bodies (or other body parts) may be detected, and the positions of their corresponding heads may be inferred. Absent such detections, control may return to 404 (or to any previous operation, such as 401-403).

At 407, if a head is detected or inferred at 406, method 400 may overlay a third graphical feature around and/or upon it to indicate the presence of a third Natural Space; that is, another person's mind. In some cases, the third graphical feature may have the same or similar visual characteristics (e.g., red hue) as the first graphical feature. In other cases, the third graphical feature have its own distinct characteristics.

At 408, method 400 may manage overlap(s) between Natural Spaces as the user of MAD 100 moves, as the user's head pose changes, and/or as persons around the user move. Method 400 may track the position of a person and/or their head, and it may modify a position and/or size of the third graphical feature to accompany the position of the person and/or head as they move around the environment, closer or farther away from the user of MAD 100.

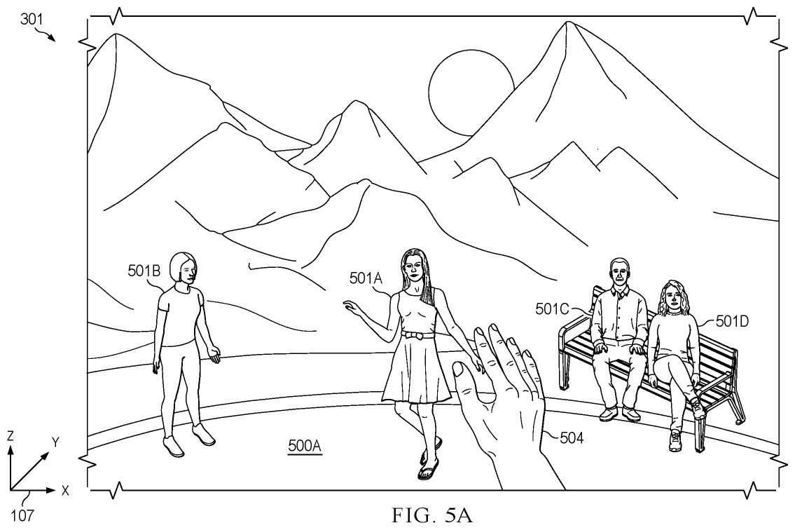

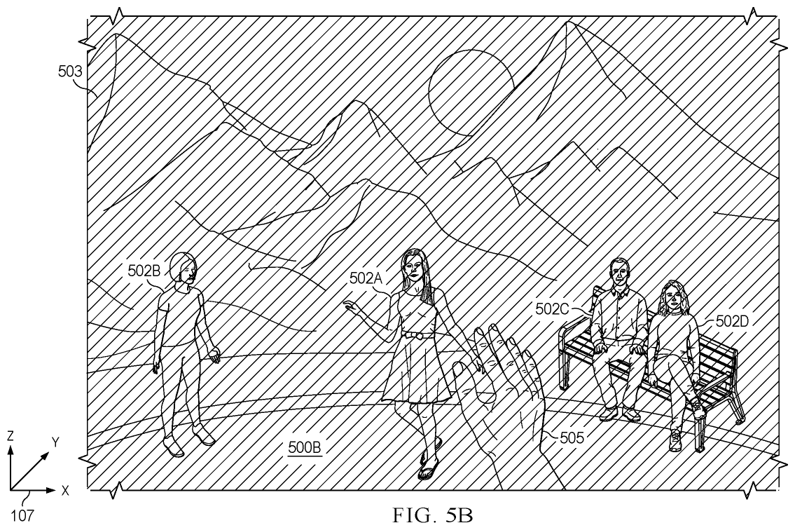

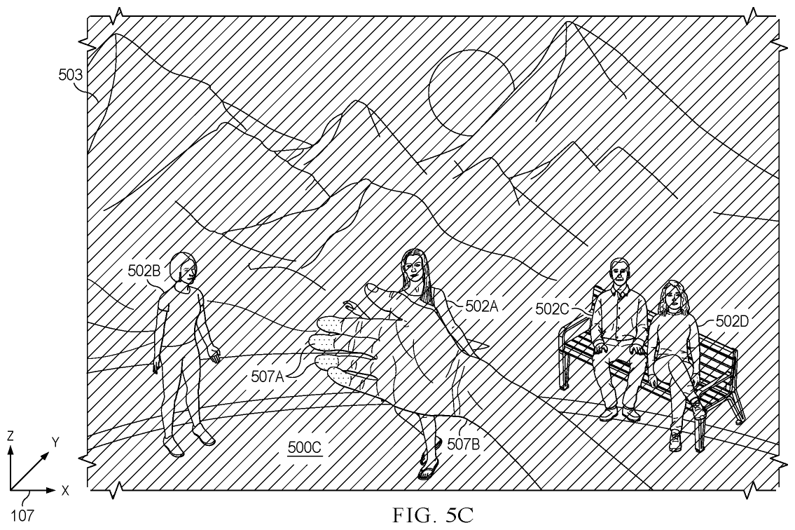

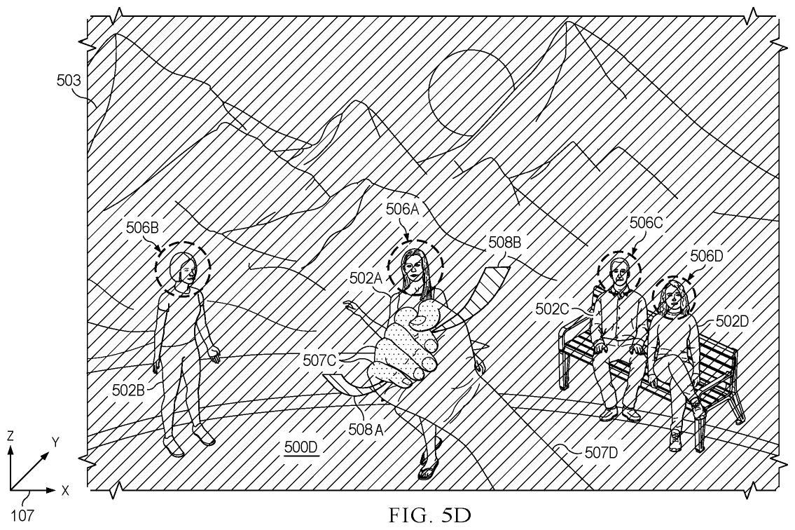

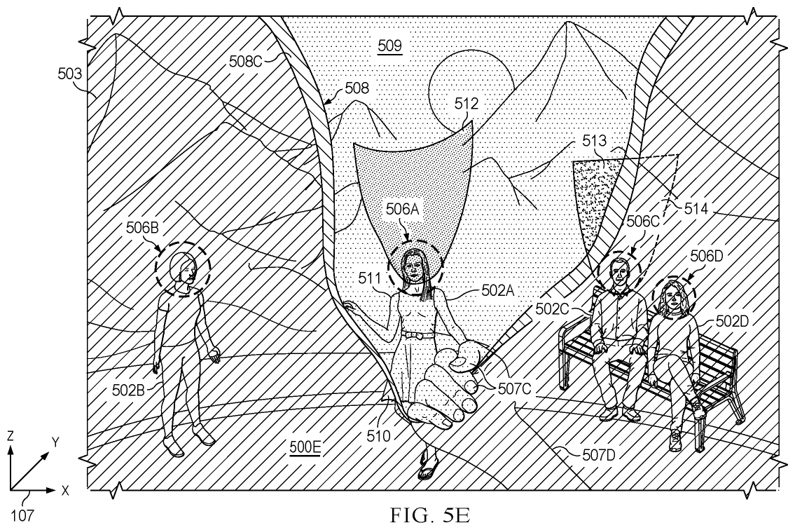

In some cases, depending upon the location of another person's head with respect to the first opening, the third graphical feature may be only partially rendered (e.g., 513 in FIG. 5E).

At 409, method 400 may detect a second gesture, command, or event by the user of MAD 100. If the second gesture is not detected, control may return to 407 (or to any previous operation, such as 401-408).

In some cases, the second gesture may include a wrapping or veiling gesture—the opposite, reverse, or inverse sequence of the unwrapping or unveiling gesture shown in FIGS. 5A-E.

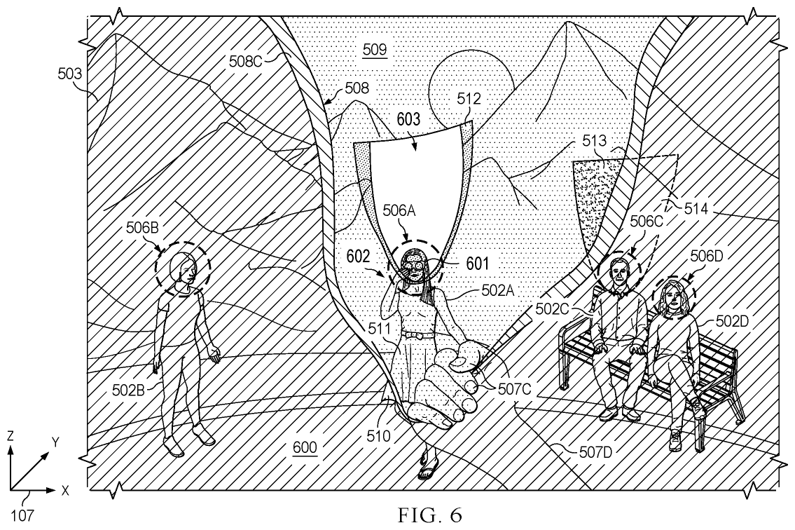

Additionally, or alternatively, the second gesture may include another unwrapping, unveiling, sliding, swiping, lifting, unzipping, or waving gesture by another person in the user's FOV (e.g., by person 502A, as shown in FIG. 6).

At 410, method 400 may modify the position, size, or visual characteristics of any of the first, second, and/or third graphical features in response to the detection of the second gesture, before control returns to 404 (or to any previous operation, such as 401-409) such that the size and/or position of the first opening may be recalculated. In some cases, the second and/or third graphical features may be removed or omitted.

For example, if the second gesture is a wrapping or veiling gesture, method 400 may reduce the size of the first opening at 404, which in turn reduces the visible area of the second graphical feature at 405.

If the second gesture is another unwrapping or unveiling gesture by another person, method 400 may: calculate a second opening for the third graphical feature at 410; and at least one of: (i) replace a portion of the third graphical feature with a fourth graphical feature in the second opening, or (ii) overlay the fourth graphical feature upon a portion of the third graphical feature corresponding to the second opening, as shown. in FIG. 6.

In alternative embodiments, the rendering or projecting of the first graphical feature at 401 may be omitted such that, prior to 402, the user may be left to naturally visualize shared space 301 without significant (or any) visual alterations.

In such embodiments, it is the user's own direct or see-through, natural view of shared space 301 that indicates, to the user, that their visual perception takes place in a first Natural Space (e.g., their mind). In these cases, the graphical feature that indicates the first opening may be referred to as a first graphical feature (not “a second graphical feature”). Similarly, the graphical feature that indicates a third Natural Space may be referred to as a second graphical feature (not “a third graphical feature”), and so on.

To further illustrate the operation of method 400, FIGS. 5A-E show non-limiting examples of AR/MR views 500A-E produced by system 300 to enable the visualization of Natural Spaces made observable to a user of MAD 100.

Particularly, AR/MR view 500A of FIG. 5A represents the user's direct or see-through, natural view of shared space 301, in full color, as seen through display(s) 102—which in some cases may have the same appearance as when the user is not wearing MAD 100. Alternatively, AR/MR view 500A may be a digital copy of the user's natural view (e.g., as captured by front-facing camera(s) 103 and rendered or projected on display(s) 102) reproduced as a live video feed, clip, movie, recording, etc.

AR/MR view 500A may include a variety of objects and surfaces, as well as persons 501A-D, present in the user's FOV of shared space 301. AR/MR view 500A may further include the user's direct or see-through, natural view of their finger(s), hand(s), wrist(s), or arm(s) 504, to the extent the user can see them through display(s) 102. At this stage, the palm of the user's hand 504 may be facing outward (or sideways).

AR/MR view 500B of FIG. 5B may be produced upon execution of method 400, showing first graphical feature 503, which may include a selected color, texture, filter, effect, or translucency (e.g., a red hue), overlaid upon all surfaces, objects, and entities present in the user's surroundings.

In FIG. 5B, original persons 501A-D of FIG. 5A may be overlaid with altered visual properties 502A-D, similar to overlay 503, but sufficiently different therefrom so that the user can still distinguish those persons' shapes and forms. In some cases, first graphical feature 503 may initially be co-extensive with the surfaces of all entities visible to the user, including persons 502A-D, as if each entity were wrapped in its own piece of the same fabric.

AR/MR view 500B may further include the user's finger(s), hand(s), wrist(s), or arm(s) 505, also overlaid with first graphical feature 503. As such, first graphical feature 503 may indicate, to the user of MAD 100, that their natural visual perception in fact takes place within a first Natural Space (e.g., the user's own mind).

In alternative implementations, AR/MR view 500B may maintain the direct or see-through, natural aspect of surfaces, objects, and entities visible to the user, without first graphical feature 503. In that case, it is the user's natural view of shared space 301 that indicates, to the user, that their visual perception of shared space 301 takes place within the first Natural Space.

AR/MR view 500C of FIG. 5C shows the beginning of an unwrapping or unveiling gesture performed by the user, such that the user's hand(s), wrist(s), or arm(s) 507B is detected in front of their face, with a palm facing inward.

In some cases, an inner portion of the user's finger(s), such as fingertip(s) 507A, may be detected apart from the rest of their hand(s), wrist(s), or arm(s) 507B. The location of fingertip(s) 507A and/or hand(s), wrist(s), or arm(s) 507B may be used to calculate a position for the inception of a first opening whereupon second graphical feature 509 (e.g., a blue hue) may be introduced to indicate the presence of a second Natural Space (e.g., shared space 301) therein.

AR/MR view 500D of FIG. 5D shows a progression of the unwrapping or unveiling gesture, where the user's hand is now in a closed position to produce a fist-like shape, with an outer portion of finger(s) 507C detected separately from the rest of hand(s), wrist(s), or arm(s) 507D.

In AR/MR view 500D, preview features 508A and 508B on or near the perimeter of the first opening may precede the rendering or projection of second graphical feature 509. In some cases, the size and/or brightness of preview features 500A and 500B may increase as the gesture progresses (e.g., as fingerprints approach the palm of the user's hand), until they turn into boundary or perimeter indication 508.

Also, AR/MR view 500D shows heads 506A-D of respective persons 502A-D detected and tracked by system 300 in response to the initiation and/or progression of the unwrapping or unveiling gesture.

In AR/MR view 500E of FIG. 5E, the user's hand has moved downward in the Z direction to pull, rip, lift, unzip, or unwrap first graphical feature 503, thereby producing the first opening where second graphical feature 509 is rendered or projected.

Still in AR/MR view 500E, second graphical feature 509 may be overlaid upon portions of surfaces, objects, and entities (e.g., person 502A) disposed at locations visible to the user through the first opening.

For example, with respect to person 502A, most of their body portion(s) 511 are located within the first opening, thus those portions are overlaid with second graphical feature 509. In contrast, portion(s) 510 remain outside of the first opening and therefore continue to be overlaid with first graphical feature 503.

Portion(s) 510 overlaid with first graphical feature 503 may indicate that the user's perception of person 502A takes place in their mind (a first Natural Space), whereas portion(s) 511 overlaid with second graphical feature 509 may indicate the presence of person 502A′s body in shared space 301 (a second Natural Space).

Incidentally, in AR/MR view 500B of FIG. 5B, the user's hand 505 is entirely overlaid with first graphical feature 503 to indicate that the user's perception of his own body also takes place within their mind. In AR/MR view 500C, the inside portions of fingertips 507A may be overlaid with second graphical feature 509 to indicate that the user is beginning to reach outside of their individual, first Natural Space, and into the second Natural Space. In AR/MR views 500D and 500E, the outer portion of finger(s) 507C may maintain the second graphical feature 509 to indicate, to the user, their own body's presence in the second Natural Space.

Still referring to AR/MR view 500E of FIG. 5E, second graphical feature 509 may replace a portion of first graphical feature 503. For example, a portion of first graphical feature 503 corresponding to the first opening may be removed, and second graphical feature 509 may be rendered or projected upon a pixel area of display(s) 102 corresponding to the first opening. Alternatively, second graphical feature 509 may be overlaid upon first graphical feature 503 in the first opening.

In some implementations, second graphical feature 509 may have a generally upside-down, triangular shape (with a bottom vertex nearest the user's pinky finger 507). In other implementations, however, other shapes may be used.

In some cases, another graphical feature 508 (e.g., a yellow hue) may be rendered along at least a portion of the edge or perimeter of the first opening to represent a boundary between distinct Natural Spaces represented by first and second graphical features 503 and 509. For example, graphical feature 508 may be an extension of preview features 508A and 508B that precede the rendering or projection of second graphical feature 509.

Because head 506A is determined to be located under second graphical feature 509 (i.e., within the first opening), third graphical feature 512 may be rendered or projected in a selected pixel position of display(s) 102 such that it appears to be at least partially overlaid upon head 506A of person 502A.

Third graphical feature 512 may replace a portion of second graphical feature 509. For example, an area of second graphical feature 509 may be removed or omitted, and third graphical feature 512 may be rendered or projected in that area. Alternatively, third graphical feature 512 may be overlaid upon second graphical feature 509.

In some implementations, third graphical feature 512 may be provided in the shape of a cone, veil, cloud, bubble, or the like. As such, third graphical feature 512 may indicate, to the user of MAD 100, the presence of a third Natural Space (person 502A's mind) distinct from the first Natural Space (the user's mind) and the second Natural Space (shared space 301).

In some implementations, third graphical feature 512 may have a closed end covering a bottom portion of person 502A's head and an open end above their head. When animated, third graphical feature 512 may wave in the air like a candle flame.

AR/MR view 500E further shows another third graphical feature 513 corresponding to head 506C of another person 502C. Because person 502C and/or its head 506C are outside of the first opening in first graphical feature 503, the shape of other third graphical feature 513 may represent a partial cone, veil, cloud, or bubble, such that remainder portion(s) 514 under second graphical feature 509 is removed or omitted.

As person 502C moves with respect to the first opening, more or less of the other third graphical feature 513 may be rendered or projected. Also, more or less of remainder portion(s) 514 may be removed or omitted. For example, if person 502C moves completely inside the first opening, or if the user of MAD 100 looks directly towards them, graphical feature 513 may take the shape of a full cone, veil, cloud, or bubble, similar to third graphical feature 512.

In AR/MR view 500E, other persons 502B and 502D do not have corresponding third graphical features associated with them because their heads 506B and 506D remain sufficiently far (i.e., beyond a selected threshold distance) from the first opening.

FIG. 6 shows AR/MR view 600 provided to the user of MAD 100 when another person 502A operating another instance 601 of MAD 100 is found nearby. The presence of MAD 601 may be detected by MAD 100 either visually (e.g., by analyzing images from camera(s) 103) and/or through wireless communication between MADs.

For example, the user of MAD 100 and person 502A may each operate their respective MADs as part of one or more video game(s), collaboration, gathering, or therapy session(s). In those cases, MAD 601 may send a message to MAD 100 indicating its own detection of unwrapping or swiping gesture 602 performed by person 502A.

In response to person 502A performing their own unwrapping or swiping gesture 602, a second opening may be produced in third graphical feature 512 visible to the user of MAD 100 such that fourth graphical feature 603 may be rendered, projected, superimposed, or overlaid upon display(s) 102.

As person 502A's gesture 602 progresses (e.g., the hand of person 502A moves), the outline of fourth graphical feature 603 may accompany its position, range, magnitude, and/or speed.

Fourth graphical feature 603 may be sufficiently different from third graphical feature 512 (e.g., different brightness, contrast, saturation, color, tone, hue, etc.) so that the user of MAD 100 can visualize a distinction between the interior and exterior portions of what otherwise constitutes the same Natural Space (le., person 502A's mind).

In some cases, head portion 506A of person 502A observable though second opening 601 may be rendered with second graphical feature 509 overlaid upon it, to maintain its appearance consistent with the rest of person 502A's body in shared space 301, as it may be seen by the user of MAD 100 inside the first opening.

In some embodiments, an unwrapping, unveiling, sliding, swiping, lifting, unzipping, or waving gesture by the user of MAD 100 may trigger a command, action, setting, or mode of interaction in a game, collaboration, or therapy session for the user of MAD 100 and/or person 502A.

Additionally, or alternatively, another unwrapping, unveiling, sliding, swiping, lifting unzipping, or waving gesture by person 502A may trigger another command, action, setting, or mode of interaction for the user of MAD 100 and/or person 502A.

Moreover, when second opening 601 is within the line-of-sight of the first opening, yet another command, action, setting, or mode of interaction may be triggered during the session, for example, as between the user of MAD 100 and person 502A.

In alternative embodiments, a conventional computing device, projector, television, monitor, or display capable of reproducing a 2D or 3D movie, picture, video, film, live feed, or animation may serve as MAD device 100. In those cases, one or more elements of views 500A-D and/or 600 may be overlaid upon image frames during or before playback, for example, to identify or highlight the presence of different Natural Spaces and/or boundaries therebetween in the movie, picture, video, film, live feed, or animation.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

To implement various operations described herein, computer program code (le., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software.

These program instructions may also be stored in a computer readable storage medium that can direct a computer system, other programmable data processing apparatus, controller, or other device to operate in a particular manner, such that the instructions stored in the computer readable medium produce an article of manufacture including instructions which implement operations specified herein.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing operations specified herein.

Reference is made herein to “configuring” a device or a device “configured to” perform one or more operations. This may include selecting predefined logic blocks and/or logically associating them. It may also include programming computer software-based logic of a retrofit control device, wiring discrete hardware components, or a combination of thereof. Such configured devices are physically designed to perform operations specified herein.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. The operational data may be collected as a single data set or may be distributed over different locations including over different storage devices.

Although certain invention(s) are described herein with reference to specific embodiments, various modifications and changes can be made without departing from the scope of such invention(s), as set forth in the claims below.

Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The terms “coupled” or “operably coupled” are defined as connected, although not necessarily directly, and not necessarily mechanically.

The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs.

In that regard, a system, device, or apparatus that “comprises,” “has,” “includes” or “contains” one or more elements possesses those one or more elements but is not limited to possessing only those one or more elements. Similarly, a method or process that “comprises,” “has,” “includes,” or “contains” one or more operations possesses those one or more operations but is not limited to possessing only those one or more operations.

1. A system, comprising:
a processor; and
a memory coupled to the processor, the memory comprising program instructions stored thereon that, upon execution by the processor, cause the system to:
render or project a first graphical feature on a display; and
at least one of: (a) replace a portion of the first graphical feature with a second graphical feature, or (b) overlay the second graphical feature upon the portion of the first graphical feature, to indicate a distinction between a user's visual perception of an environment and the environment.

2. The system of claim 1, wherein each of the first and second graphical features comprises at least one of: a color, a hue, a filter, an effect, a texture, or an image.

3. The system of claim 1, wherein the user's visual perception of the environment is produced within a first Natural Space, and wherein the environment is part of a second Natural Space.

4. The system of claim 1, wherein the program instruction, upon execution by the processor, cause the system to maintain the second graphical feature at a same relative location in a Field-of-View (FOV) of a user as the user moves.

5. The system of claim 1, wherein at least one of the first or second graphical features is translucent.

6. The system of claim 1, wherein the program instructions, upon execution by the processor, cause the system to, at least one of: (i) replace a portion of the first graphical feature with a third graphical feature, (ii) replace a portion of the second graphical feature with the third graphical feature, (iii) overlay the third graphical feature along at least a portion of a perimeter of the first graphical feature, or (iv) overlay the third graphical feature along at least a portion of a perimeter of the second graphical feature.

7. The system of claim 1, wherein the distinction is indicated in response to at least one of: (i) a gesture comprising an unwrap, unveil, slide, swipe, lift, unzip, or wave gesture, (ii) a command comprising a keypress, a mouse click, a button push, an audio command, a typed command, or a programmed command, or (iii) an event comprising an object detection, a game event, or an application event.

8. The system of claim 7, wherein the program instructions, upon execution by the processor, cause the system to increase a size of the second graphical feature in response to an increase in a range, magnitude, or speed of the gesture.

9. The system of claim 7, wherein the program instructions, upon execution by the processor, cause the system to reduce a size of the second graphical feature in response to a decrease in a range, magnitude, or speed of the gesture.

10. The system of claim 7, wherein the program instructions, upon execution by the processor, cause the system to, in response to another gesture, command, or event: (i) remove the second graphical feature, or (ii) replace the second graphical feature with the first graphical feature.

11. The system of claim 10, wherein the other gesture is opposite to the gesture.

12. The system of claim 1, wherein the program instructions, upon execution by the processor, cause the system to, in response to a person being visible to a user through the second graphical feature, render or project a third graphical feature upon a portion of the display corresponding to the person's head.

13. The system of claim 12, wherein the third graphical feature comprises a translucent shape having a closed end covering a bottom portion of the person's head, and an open end above the person's head.

14. The system of claim 12, wherein the program instructions, upon execution by the processor, cause the system to, in response to at least a portion of the person's head not being visible to the user through the second graphical feature, omit, reduce, or remove at least a portion of the third graphical feature.

15. The system of claim 12, wherein the program instructions, upon execution by the processor, cause the system to animate the third graphical feature.

16. The system of claim 12, wherein the program instructions, upon execution by the processor, cause the system to track at least one of: the person, or the person's head, and modify a position of the third graphical feature to follow at least one of: the person, or the person's head.

17. The system of claim 12, wherein the program instructions, upon execution by the processor, cause the system to, at least one of: (i) replace a portion of the third graphical feature with a fourth graphical feature, or (ii) overlay the fourth graphical feature upon a portion of the third graphical feature.

18. The system of claim 17, wherein the program instructions, upon execution by the processor, cause the system to, in response to a determination that the fourth graphical feature is visible to the user through the second graphical feature, trigger a command, action, or interaction between the user and the person.

19. A memory device having program instructions stored thereon that, upon execution by a processor, cause a Metaverse Access Device (MAD) to:
detect a gesture, command, or event; and
in response to the detection, overlay a graphical feature upon a user's view of an environment to indicate a boundary between two or more Natural Spaces.

20. A method, comprising:
operating a Metaverse Access Device (MAD); and
visually identifying a first Natural Space as distinct from a second Natural Space as a result of the operation.
